(19) United States
(12) Patent Application Publication
(10) Pub. No.: US 2026/0145966 A1
(43) Pub. Date: May 28, 2026

(54) FILTER CARTRIDGE FOR TREATING DRINKING WATER

(71) Applicant: DE' LONGHI APPLIANCES S.R.L., Treviso (IT)

(72) Inventors: Franco Uva, Lonigo (VI) (IT); Enrico Barbero, Pressana (VR) (IT); Marco Genre, Noale (VE) (IT)

(73) Assignee: DE' LONGHI APPLIANCES S.R.L., Treviso (IT)

(21) Appl. No.: 19/123,969

(22) PCT Filed: Oct. 24, 2023
(86) PCT No.: PCT/IB2023/060724

§ 371 Date: Apr. 24, 2025

(30) Foreign Application Priority Data
Oct. 24, 2022 (IT) 102022000021927

(51) Int. Cl. C02F 1/28; C02F 1/42

(52) U.S. Cl. CPC C02F 1/283; C02F 1/42; C02F 2201/006

(57) ABSTRACT

A filter cartridge for treating drinking water comprises a casing which contains a filter material for treating the water and which has at least one inlet for the water to be treated and at least one outlet for the treated water. The filter cartridge further comprises irreversible opening means which are configured in such a manner that, when used, there remains defined in the filter cartridge an opening which is suitable for allowing the removal, at least partially, of the filter material from the casing.

### TECHNICAL FIELD

The present invention relates to a filter cartridge for treating drinking water.

### TECHNOLOGICAL BACKGROUND

Nowadays, the use of filter cartridges is widespread for applications, in order to improve the quality of water, in tanks of apparatuses for preparing beverages, such as coffee or generally hot drinks, or in filter jugs, or for intercepting the intake of water to the apparatuses, if they are directly connected to the water supply system. An example of such apparatuses is machines for domestic use, where a tank is provided for containing the water necessary for preparing a specific number of beverages and is connected to the supply circuit of the machine. Other apparatuses may be, for example, machines for domestic use or for cafes and the like, which are connected directly to the water supply system and in which the water necessary for preparing the beverages is filtered upstream of the supply circuit, intercepting the intake of the water supply system and therefore the connection piping to the machine. Similarly, these cartridges are also applied to water distributors and refrigerators.

An additional possible application of these filter cartridges is in the piping under sinks in order to supply to the user filtered water being discharged from the tap.

Cartridge filtration systems, which are also known as “cartridge filters”, at least partially eliminate the impurities present in the water and soften it, improving the organoleptic qualities thereof and reducing the quantity of limestone present therein which may be the cause of limescale incrustations in the circuit and consequently damage to the machines.

Typically, the cartridge has a casing with a containment portion for a filter material which has to be passed through by the water to be treated, and, to this end, there are present on the casing at least one inlet for the water to be treated and at least one outlet for discharging the treated water.

In machines for preparing the hot beverages, the water is caused to flow through the filter material using, for example, a suction mechanism as a result of being drawn towards the boiler of the machine. To this end, in the case of a machine with a tank, the cartridge is connected in a fluid-tight manner and in a removable manner with a coupling in the region of a discharge opening from the tank.

In these cases, the cartridge has, in the lower zone, inlet openings for the water towards a first containment chamber for the filter material and, still in the lower zone, discharge openings from a second chamber, which is in fluid connection with the first chamber, for discharging the water towards the supply circuit of the machine.

An example of a filter cartridge to be applied in a tank for coffee machines or generally for preparing hot drinks is described in the European patent EP1340442.

However, the Applicant has observed that these types of known cartridges have the disadvantage of not being able to be recycled once the service-life of the filter material has come to an end. In fact, it must be understood that a correct disposal directed towards recycling of the materials from which these types of cartridge are formed requires the separation of the filter material from the casing, the first item typically being constituted by an admixture containing activated carbon, silicates and other components and the second item typically being made of plastics material.

The same disadvantage is encountered in the cartridges to be connected to the pipes and also in the cartridges for filter jugs. Among these types of cartridges it is known to provide for the use of a casing which is subdivided into two different portions: a lower portion which is substantially cup-like and which is able to contain the filter material, and an upper cover.

An example of this type of cartridge is described in the patent DE202021001538.

The solution adopted for jug cartridges is not applicable to cartridges for tanks which are connected to the supply circuit of the machines, there being necessary an excellent fluid-tightness in order to ensure correct inflow of water along the filtration path which is defined by the cartridge. Furthermore, in the cartridges for coffee machines, the separation line between the portions has to be under the minimum level of water in the tank so that air is not drawn in towards the boiler. Alternatively, the fluid-tightness between the two portions would have to be ensured, for example, by inserting a seal with a resultant increase in the production costs.

Therefore, there remains the perception of a need to be able to correctly dispose of the filter cartridge, by opening it in an easy and rapid manner in order to extract the content from the casing.

### STATEMENT OF INVENTION

The object of the present invention is to provide a filter cartridge which is able to improve the prior art in one or more aspects indicated above.

In the context of this object, an objective of the invention is to provide a filter cartridge which is adapted to be disposed of as recyclable waste. Another objective of the invention is to provide a filter cartridge for which it is possible to correctly dispose of the different portions which compose it.

It is also an object of the invention to provide a filter cartridge which can be opened in an easy and rapid manner without impairing the sealing of the liquid therein.

Another object of the invention is to overcome the disadvantages of the prior art as an alternative to other existing solutions.

Yet another object of the invention is to provide a filter cartridge which can be opened and disposed of correctly, at the same time containing the production costs thereof.

Another object of the invention is to provide a cartridge which is readily recyclable in the context of a rational solution and with contained costs.

This object and one or more of the above-mentioned objectives are at least partially achieved by a filter cartridge for treating water, which comprises a casing which contains a filter material for treating the water and which has at least one inlet for the water to be treated and at least one outlet for the treated water.

Preferably, the filter cartridge comprises irreversible opening means for the casing, the irreversible opening means preferably being configured in such a manner that, when used, there remains defined in the filter cartridge an opening which is suitable for allowing the removal, at least partially, of the filter material from the casing.

In the context of the present invention, the term “irreversible” with reference to opening means is intended to be understood to refer to these means being able to allow the casing to be opened, or another element to which they are applied, without then allowing subsequent closure thereof, at least in the absence of additional means or elements. The irreversibility of the opening means may, for example, be obtained by providing a breakable portion in the opening means so that, during opening, this portion necessarily has to be subjected to breaking.

In particular, the Applicant has observed that if the irreversible opening device is of the type able to bring about at least partial breakage of the casing, it cannot be re-used, ensuring with a new cartridge the fluid-tightness in the region of the discharge opening.

At the same time, by way of the opening means, it is possible to provide an opening in the casing through which to extract the filter material present inside the cartridge.

Once this material has been extracted, the casing which is typically made from plastics material may be treated as a recyclable waste item by therefore decreasing significantly the environmental impact resulting from the use of these cartridges.

On the basis of a second aspect, the invention also relates to a method for disposing of a filter cartridge. The filter cartridge comprises a casing which contains a filter material for treating water and having at least one inlet for the water to be treated and at least one outlet for the treated water.

Preferably, the filter cartridge comprises irreversible opening means of the casing, the irreversible opening means preferably being configured in such a manner that, when used, there remains defined an opening in the filter cartridge which is suitable for allowing the at least partial removal of the filter material from the casing.

The method comprises opening the casing by way of the irreversible opening means when the filter material has depleted the filtration capacity, by removing the filter material from the casing through the opening, and separately disposing of the casing and the filter material.

The following additional preferred features are used in the present invention on the basis of any of the previously defined aspects.

In addition, additional preferred, though non-exclusive, features of the invention are further defined in the dependent claims.

In some embodiments, the irreversible opening means are preferably formed on the casing.

The casing is preferably formed by moulding and the irreversible opening means are preferably formed on the casing during the same moulding step.

The fact of not separately forming the opening means and of not having to assemble them with other parts allows the costs to be contained and also the production times.

On the basis of yet another aspect of the invention, the irreversible opening means of the casing preferably comprise an opening portion in the casing, which at least partially allows the provision of the extent of breaking the casing itself and allows it to be limited.

In this manner, the opening which is defined by the use of the opening means may be located in a precise manner and therefore advantageously arranged so as to simplify the extraction of the filter material and/or to ensure complete removal thereof.

On the basis of another aspect of the invention, the opening portion of the casing is preferably at least partially delimited by a desired breaking line, substantially a guiding line for opening.

As a result of this feature, the opening means can be constructed in a structurally simple manner without requiring additional construction steps with respect to steps typically provided for constructing the known cartridges, such as, for example, moulding plastics materials.

Preferably, the desired breaking line is defined by a thickness reduction of the wall of the casing.

In this manner, the desired breaking line can be directly obtained during the moulding steps of the cartridge, avoiding a situation in which the presence of the opening means causes additional production costs.

Preferably, the opening portion is separable from the remainder of the casing, preferably by tearing.

The term “tearing” in the context of the present invention is intended to be understood to mean that an element can be separated, without necessarily removing it, from a member to which it is fixed by means of a pulling action in a direction away from the member itself. This action is preferably carried out manually, that is to say, the connection between the element and member is such that a manual action by a user is simply necessary in order to bring about the separation thereof. It is thereby possible to carry out the opening of the casing with a simple action by the user which, however, at the same time, is quite difficult to be carried out inadvertently, that is to say, at times at which it is not necessary to eliminate the filter material from the cartridge.

In some embodiments, the irreversible opening means comprise a gripping element which preferably projects from the casing.

In this manner, the irreversible opening means can be readily manipulated. Furthermore, particularly if the opening means are located in the region of the cover, the same gripping element can also be used to grip and to extract the cartridge from the tank during normal use.

Preferably, the gripping element includes a tongue which projects from the opening portion so as to be able to grip the gripping element in a simple manner, both while the cartridge is being manipulated and in order to carry out the opening of the casing. Preferably, the irreversible opening means comprise a breakable portion which is configured so as to connect the opening portion to the casing and so as to be broken following movement of the opening portion away from the casing.

In this manner, it is possible to make the opening means irreversible simply by means of the opening action of the casing with a particularly simple and effective solution from the construction point of view.

Since the opening means are preferably constructed in the same moulding steps of the cartridge, they do not add any production costs either in the production step or in the assembly step.

Preferably, there is defined inside the casing at least one chamber which is for containing the filter material and which has the at least one inlet, for the water to be treated, and the at least one outlet, for the treated water, the chamber in turn defining a filtration path which places the at least one inlet in communication with the at least one outlet.

Preferably, in the region of the inlet a first filter for retaining the filter material is present.

In some embodiments, in the region of the outlet a second filter for retaining the filter material is present.

Preferably, the opening portion faces at least the chamber.

As a result of one or more of these features, the cartridge can be readily emptied of the filter material which is present therein, the opening portion being suitably arranged.

In some embodiments, the cartridge has a shell, around at least a portion of the casing, which can be opened and which defines with the external wall of the casing a volume which can contain limescale prevention material, the shell having openings for the passage of water inside the volume.

The shell is preferably openable via suitable opening means.

In this manner, the cartridge is able to reduce the content of limescale present in the water and at the same time to filter it while ensuring the correct disposal of the portions thereof when use is at an end.

Additional preferred aspects are also defined in the appended claims and the following description.

### BRIEF DESCRIPTION OF THE DRAWINGS

Additional features and advantages of the invention will be better appreciated from the description of a preferred though non-exclusive embodiment of the filter cartridge according to the invention which is illustrated by way of non-limiting example in the appended drawings, in which:

FIG. 1 is a perspective view of the filter cartridge according to the invention in a first embodiment thereof;

FIG. 2 is a perspective view, as a cross-section, of the filter cartridge as in FIG. 1;

FIG. 3 is a detail of the filter cartridge in cross-section;

FIG. 4 is a perspective view of the filter cartridge according to the invention during the removal of an opening portion thereof;

FIG. 5 is a perspective view of the filter cartridge according to the invention after the removal of the opening portion thereof;

FIG. 6 is a perspective view of the filter cartridge according to the invention in a second embodiment thereof;

FIG. 7 is a cross-section of the filter cartridge as in FIG. 6;

FIG. 8 is a perspective view of a portion of filter cartridge as in FIG. 6, from which a relevant shell has been removed.

### PREFERRED EMBODIMENT OF THE INVENTION

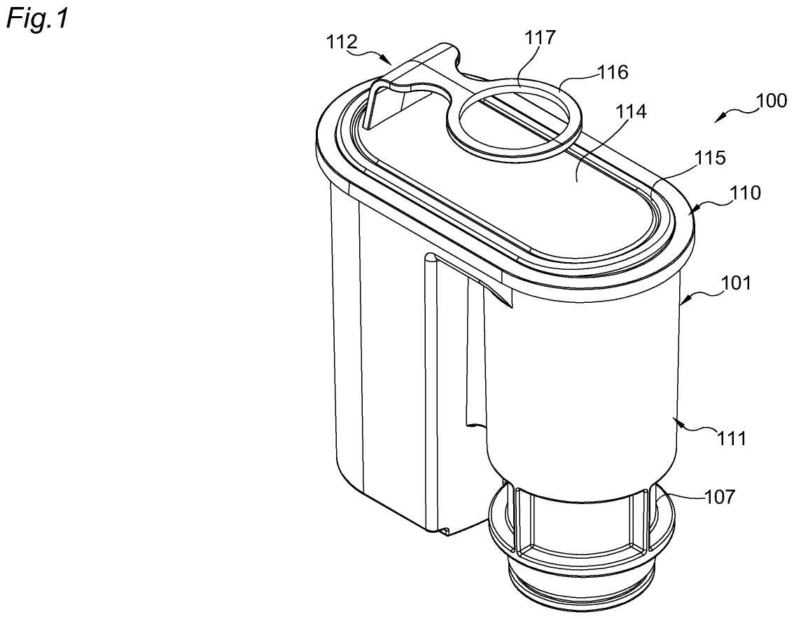

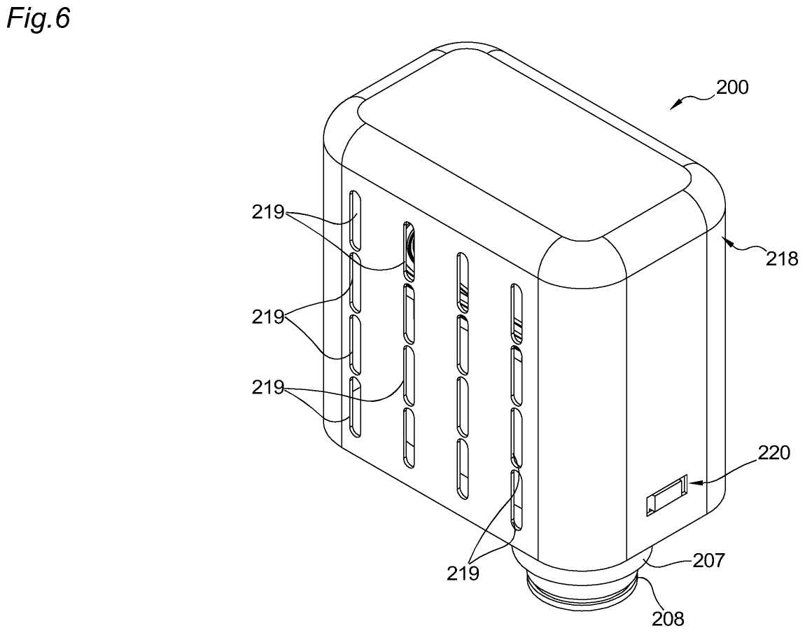

With reference to FIGS. 1 to 5, there is generally designated 100 the filter cartridge according to the invention in a first embodiment thereof. In a second embodiment thereof, the filter cartridge according to the invention is generally designated 200 and is illustrated in FIGS. 6 to 8. This filter cartridge 100, 200 can be used in a tank which is suitable for containing water for preparing beverages. In particular, the filter cartridge 100, 200 can be configured to meet the softening requirements of the water contained in the tanks for coffee machines or more generally for preparing hot drinks. However, the same inventive concept is applicable to filter cartridges for softening, and more generally treating, water which is contained in jugs. The same concept can again be applied to filter cartridges for installation, for example, in the region of water intake pipes to apparatuses, such as machines for preparing beverages, water dispensers and refrigerators, or under sinks. As shown in the Figures, the filter cartridge 100, 200 comprises a casing 101, 201 which contains a filter material which is not illustrated in the Figures for treating the water and which has at least one inlet 102, 202 for water to be treated and at least one outlet 103, 203 for the treated water. The casing 101, 201 is preferably made from plastics material while the filter material is typically but not exclusively constituted by an admixture in the form of granules which contain, for example, an admixture of ion exchange resin and/or activated carbon.

The example of a filter cartridge 100, 200 shown in the Figures is applicable in a tank for machines for preparing beverages.

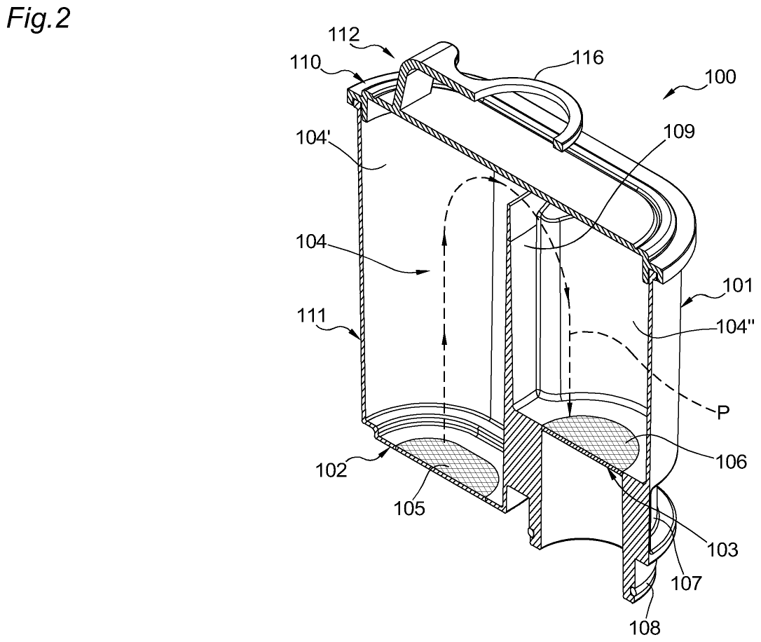

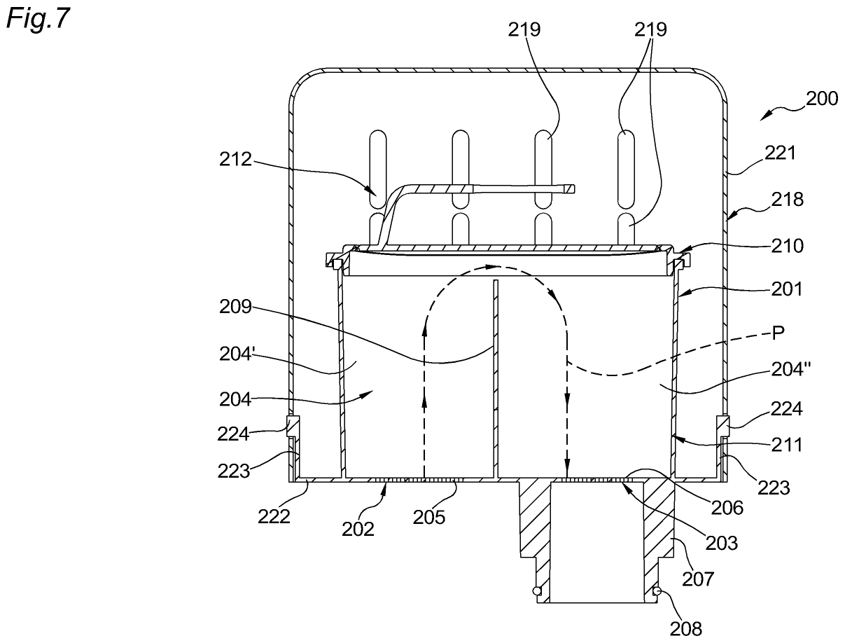

According to this example, as can be seen in FIG. 2 and FIG. 7, there is defined inside the casing 101, 201 a chamber 104, 204 (in other embodiments, there may be more than one) which is for containing the filter material (not illustrated) and which has the inlet 102, 202 (in other embodiments, more than one inlet may be present) for the water to be treated, in the region of which a first filter 105, 205 for treating the filter material is present. Again, the chamber 104, 204 also has an outlet 103, 203 (in other embodiments, more than one outlet may be present) for the treated water, in the region of which a second filter 106, 206 again for treating the filter material is present. The chamber 104, 204 defines in turn a filtration path P which is schematically illustrated in FIG. 2 and FIG. 7 and which places the inlet 102, 202 in communication with the outlet 103, 203.

In some embodiments, as in the cases still illustrated in FIG. 2 and in FIG. 7, the chamber 104, 204 is subdivided into two portions, which are substantially cup-like: a first portion 104′, 204′ in the region of the bottom which the inlet 102, 202 is present with the first filter 105, 205 and a second portion 104″, 204″ in connection with the first portion 104′, 204′ and in the region of the bottom of which the outlet 103, 203 is present with the second filter 106, 206.

In preferred embodiments, there develops from the second portion 104″, 204″, in addition to the second filter 106, 206, a hollow projection 107, 207 which is provided, with the seal 108, 208 thereof, for connection in a fluid-tight manner to a coupling which is typically present at the bottom of the tank and in the region of an outlet opening for the water towards the supply circuit of the machine.

Preferably, the connection between the two portions 104′, 204′ and 104″, 204″ is brought about in the upper portion thereof (with respect to the installation position of the cartridge which corresponds to the position illustrated in the Figures and which, during normal use of the cartridge, is directed upwards), beyond a partition wall 109, 209 which separates them and which is therefore under a cover 110, 210 for closing the casing 101, 201.

The path P thereby follows a substantial U-shape between the inlet 102, 202 and the outlet 103, 203.

There can substantially be identified two main portions of the casing, a lower portion 111, 211 which comprises the chamber 104, 204 and an upper portion which corresponds to the cover 110, 210. The cover 110, 210 is suitably installed above the two portions 104′, 204′ and 104″, 204″ in a step for constructing the filter cartridge 100, 200 and is preferably thermally welded to the upper perimetral edge of the lower portion 111, 211.

The filter cartridge 100, 200 according to the invention advantageously comprises irreversible opening means 112, 212 which are configured in such a manner that, when used, there remains defined in the filter cartridge 100, 200 an opening 113, 213 which is suitable for allowing the, at least partial, removal of the filter material from the casing 101, 201.

Preferably, the irreversible opening means 112, 212 are formed in the casing 101, 201. This is carried out by moulding and the opening means 112, 212 are formed in the casing during the same moulding step.

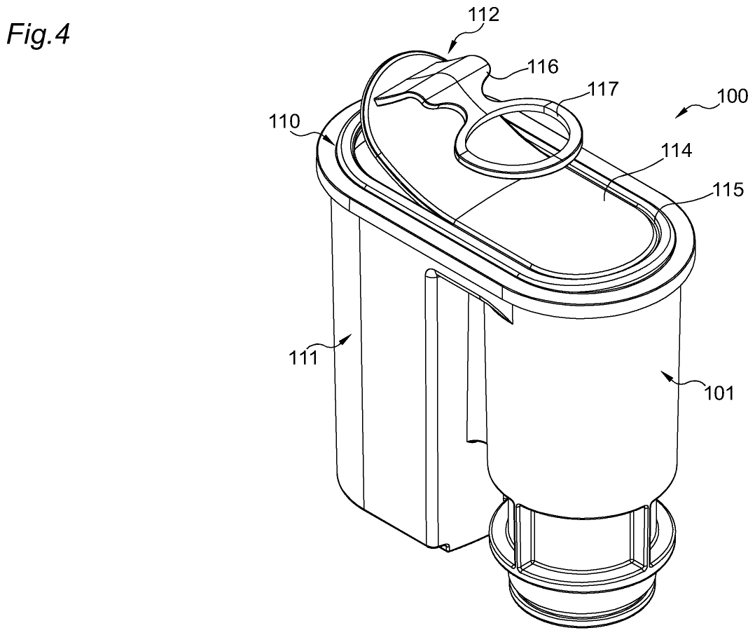

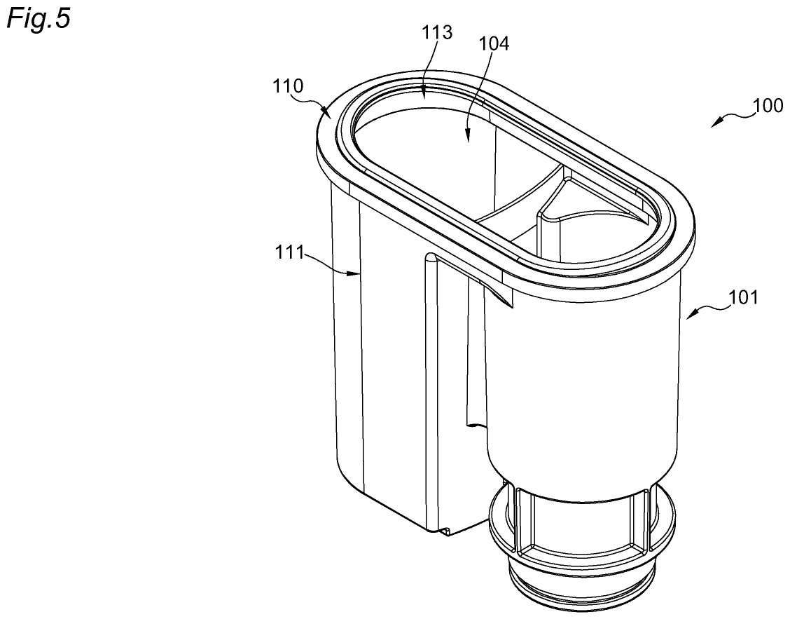

FIG. 4 illustrates the same filter cartridge 100 which is illustrated in FIGS. 1 and 2, during the opening thereof by way of the irreversible opening means 112. FIG. 5 instead illustrates the filter cartridge 100 at the end of the opening thereof, in a state completely without an upper portion, in a manner which will be appreciated more clearly below.

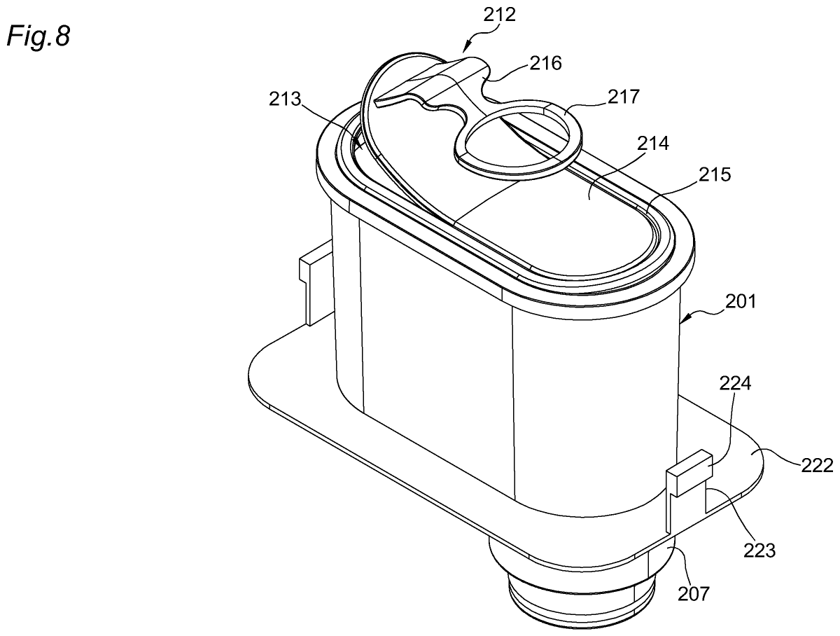

For the second embodiment, FIG. 8 shows the opening of the casing 201 of the filter cartridge 200.

In preferred embodiments, the above-mentioned irreversible opening means 112, 212 are of the type suitable for bringing about at least partial breaking of the casing 101, 201.

To this end, the irreversible opening means 112, 212 may comprise an opening portion 114, 214 in the casing 101, 201 which is at least partially removable so as to define the opening 113, 213.

The term “removable” with reference to the opening portion 114, 214 is intended to be understood in this instance so that this portion is at least partially separable from the remainder of the casing 101, 201.

In some embodiments, the opening portion 114, 214 is delimited perimetrally by a desired breaking line 115, 215, as can be seen in FIG. 1 and in FIG. 8. In other cases, which are not illustrated, the desired breaking line may delimit the opening portion only partially.

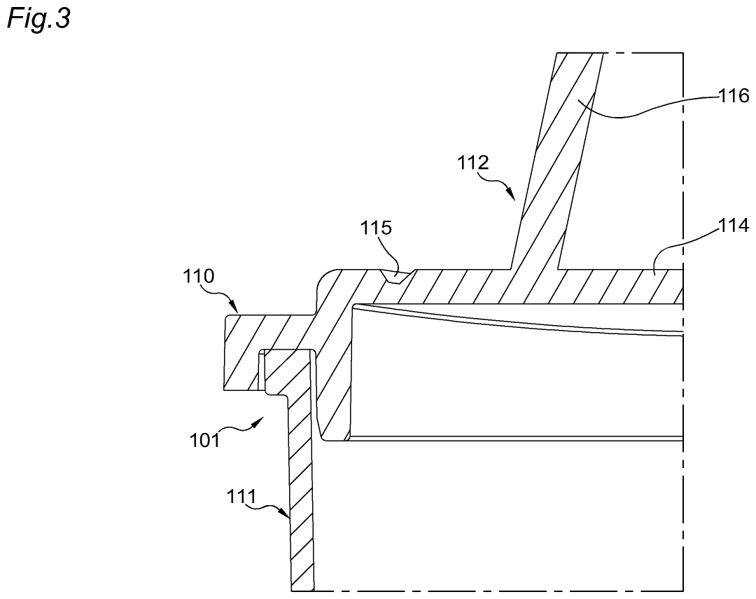

Preferably, this desired breaking line 115, 215 is defined by a thickness reduction of the wall of the casing 101, 201, for example, by a groove, as shown with the enlarged view of FIG. 3.

In preferred embodiments, such as, for example, in the case illustrated, the desired breaking line 115, 215 and the relevant opening portion 114, 214 are located on the cover 110, 210. In other embodiments of the same invention, however, they can be located on a side wall of the lower portion 111, 211 or on the bottom, for example, if the inlet and outlet are arranged in the upper portion of the cartridge.

Advantageously, this arrangement on the cover allows, if there are provided two different portions in the cartridge, as in the case described above, a situation in which the opening 113, 213 faces both the portions, therefore allowing easy removal of the filter material from both.

The opening portion 114, 214 is separable, preferably by tearing from the remainder of the casing 101, 201.

Advantageously, the irreversible opening means 112, 212 comprise a gripping element 116, 216 which preferably projects from the casing 101, 201. A tearable opening can be obtained by forcing the opening portion 114, 214 by means of the gripping element 116, 216. In the embodiments illustrated, the opening portion 114, 214 corresponds to a wall portion of the casing 101, 201, in particular a cover portion 110, 210, and the gripping element 116, 216 involves a tongue which projects from the opening portion 114, 214. The tongue may have, as in the case illustrated, a hole 117, 217, preferably with such a width as to allow the passage of at least one finger in order to facilitate the gripping thereof by the user.

As illustrated, the gripping element 116 projects from the opening portion 114 in a preferably decentralized position, inside the area which is circumscribed by the desired breaking line 115, preferably near it. In order to separate the opening portion 114 from the remainder of the casing 101 by tearing, the gripping element 116 can be pulled by the user upwards or towards the opposite side to the one in which it is arranged (with it being decentralized) until lifting the opening portion 114 outwards. Alternatively, the gripping element 116 can be urged to rotate in the opposite direction, in this case acting as a lever in order to force the lowering of the opening portion 114 towards the inner side of the casing 101, in this case also bringing about a tearing along the desired breaking line 115 (as occurs in the opening mechanism of aluminium cans, which is also known as a “stay-on tab” in English-speaking countries). The opening portion 114 preferably has such a thickness as to be able to be folded during opening.

Similar considerations apply to the second embodiment of the filter cartridge 200.

In order to make these operations easier, it is preferable for the gripping element 116, 216 to have a substantially inverted L-shaped cross-section, with a first portion developing perpendicularly relative to the opening portion 114, 214 and so as to follow a second portion which develops parallel with the same opening portion.

In an alternative embodiment, which is not illustrated, the gripping element may involve a screw cap which is intended to be separated by tearing from the remainder of the casing along a defined breaking line by weakening the structure, similarly to screw caps with a seal which is commonly already used for bottles.

In another possible embodiment, which is also not illustrated, the breaking line may be defined perimetrally and transversely in the lower portion of the casing. In this case, a projecting gripping element may not be present.

Irrespective of the embodiment of the invention, it is preferable for the opening portion 114, 214 to face at least the chamber 104, 204, as in the embodiments illustrated, in order to promote the removal of the filter material from the casing 101, 201.

The filter cartridge 200, in the second embodiment thereof, differs from the filter cartridge 100 as a result of the presence of a shell 218, about at least a portion of the casing 201, which can be opened and which defines with the external wall of the casing 201 a volume which is suitable for containing limescale prevention material. The shell 218 has openings 219 for the passage of water inside the volume.

The shell 218 comprises auxiliary opening means 220 which are preferably of the reversible type. Alternatively, these opening means may define a breaking of the shell.

In the embodiment shown, the shell 218 comprises a receiving portion 221, which is inverted in the position for use thereof and inside which there is present a portion of the casing 201, in this case comprising the chamber 204 and the cover 210 and a base which develops externally from the casing 201 and on which the receiving portion 221 closes. There develop from the base 222, which can be seen in FIG. 7 and in FIG. 8, two opposite blocking tongues 223 with reliefs 224 which can be inserted into corresponding additional openings which are present in the receiving portion 221 and which form therewith the opening means 220 of the shell 218. The shell 218, as for the casing 201, is preferably made from plastics material.

Furthermore, the lower portion 211 of the shell 201 and the base 222 are preferably formed in a single piece by means of a single moulding step.

The use of the filter cartridge according to the invention is as follows.

When the filter cartridge 100 is depleted, the user can open it simply and preferably by pulling the gripping element 116 with a tongue in order to bring about tearing of the opening portion 114 along the desired breaking line 115 until it is at least partially separated from the remainder of the cover 110, at the same time lifting it as shown in FIG. 4.

Alternatively, the user may rotate the same gripping element 116 towards the desired breaking line portion 115 near which the same element projects, by at least partially urging the opening portion 114 towards the inner side of the casing 101.

By at least partially tearing the opening portion 114, there remains defined the opening 113 in the filter cartridge 100, promoting the emptying thereof. The opening portion 114 can in fact be completely removed, as shown in FIG. 5, or only partially removed, as in the intermediate configuration shown in FIG. 4.

In this manner, the depleted filter cartridge 100 can be correctly disposed of by discarding the filter material and the casing into the respective types of waste.

Furthermore, the opening portion is no longer available for closing the casing 101 of the filter cartridge 100 which therefore cannot be re-used, thereby preventing any risk that incorrectly operating cartridges may be installed in the tank of the machine.

The opening of a filter cartridge 200 in the second embodiment particularly requires the opening of the shell 218, by the auxiliary opening means 220, by urging the tongues 223 to leave with the reliefs 224 from the respective openings of the receiving portion. In this manner, it is possible to empty the cartridge of the limescale prevention material. Subsequently, the above-described operations for the cartridge 100 can be carried out for this cartridge 200.

In practice, it has been found that the invention achieves the object and the objectives set out by providing a filter cartridge which can be opened by the user in an easy and rapid manner, at the same time facilitating correct disposal of the cartridge, which cannot be re-closed, thereby preventing the cartridge from being able to be re-used by replacing the filter material which was originally contained therein.

It may also be noted that the presence of a desired breaking line, delimiting the area of breakage of the casing, that is to say, the opening portion, allows the provision of the maximum opening extent and allows it to be limited.

It may further be noted that the fact of forming the irreversible opening means directly on the casing allows the production costs of the filter cartridge to be contained.

The invention is capable of a number of modifications and variants in addition to those described, all being included within the scope of the inventive concept.

1. A filter cartridge for treating drinking water, which comprises a casing which contains a filter material for treating the water and which has at least one inlet for the water to be treated and at least one outlet for the treated water,
wherein the filter cartridge comprises irreversible opening means for the casing, the irreversible opening means being configured in such a manner that, when used, there remains defined in the filter cartridge an opening which is suitable for allowing the removal, at least partially, of the filter material from the casing

2. The filter cartridge of claim 1, wherein the irreversible opening means are formed on the casing.

3. The filter cartridge of claim 1, wherein the opening has dimensions which are greater than the inlet and the outlet.

4. The filter cartridge of claim 1, wherein the opening is different with respect to the inlet and the outlet.

5. The filter cartridge of claim 1, wherein the irreversible opening means are of the type suitable for bringing about at least partial breaking of the casing.

6. The filter cartridge of claim 1, wherein the irreversible opening means comprise a breakable portion, the breakable portion being configured in such a manner that the breakable portion is subjected to breaking following an opening action of the casing by a user so as not to allow subsequent closure of the casing.

7. The filter cartridge of claim 1, wherein the casing and the irreversible opening means are formed as a single piece, being able to be separated by breaking the breakable portion.

8. The filter cartridge of claim 1, wherein the casing is constructed by moulding and the irreversible opening means are formed on the casing during the same moulding step.

9. The filter cartridge of claim 1, wherein the casing and the irreversible opening means, are both made from plastic material.

10. The filter cartridge of claim 1, wherein the casing and the irreversible opening means, are both made from same material.

11. The filter cartridge of claim 1, wherein the irreversible opening means comprise an opening portion in the casing, the opening portion being at least partially removable so as to define the opening.

12. The filter cartridge of claim 11, wherein the opening portion is at least partially delimited by a desired breaking line.

13. The filter cartridge of claim 12, wherein the desired breaking line is defined by a thickness reduction of the wall of the casing.

14. The filter cartridge of claim 11, wherein the opening portion defines the breakable portion.

15. The filter cartridge of claim 11, wherein the opening portion is separable from the remainder of the casing by tearing.

16. The filter cartridge claim 1, wherein the irreversible opening means comprise a gripping element which preferably projects from the casing.

17. The filter cartridge of claim 16, wherein the gripping element involves a tongue which projects from the opening portion.

18. The filter cartridge accordi of claim 1, wherein there is defined inside the casing at least one chamber which is for containing the filter material and which has the at least one inlet, for the water to be treated, in the region of which a first filter for retaining the filter material is present, and the at least one outlet, for the treated water, in the region of which a second filter for retaining the filter material is present, the chamber in turn defining a filtration path which places the at least one inlet in communication with the at least one outlet.

19. The filter cartridge of claim 17, wherein the opening portion faces at least the chamber.

20. The filter cartridge of claim 1, wherein the filter material comprises an admixture in the form of granules.

21. The filter cartridge of claim 1, wherein the filter material comprises an admixture of ion exchange resin and/or activated carbon.

22. The filter cartridge of claim 1, comprising a shell, the shell being arranged around at least a portion of the casing and being able to be opened, the shell defining with the external wall of the casing a volume which can contain limescale prevention material, the shell having openings for the passage of water inside the volume.

23. The filter cartridge of claim 22, wherein the shell comprises auxiliary opening means.

24. A method for disposing of a filter cartridge (100; 200) comprising:
opening the casing by way of the irreversible opening means when the filter material has depleted the filtration capacity;
removing the filter material from the casing through the opening; and
separately disposing of the casing and the filter material.

25. The method for disposing of a filter cartridge of claim 24, wherein the opening of the casing by way of the irreversible opening means comprises breaking, in an irreversible manner, the casing in the region of the opening (113; 213).
